(19) United States
(12) Patent Application Publication
(10) Pub. No.: US 2020/0072723 A1
(43) Pub. Date: Mar. 5, 2020

(54) Portable Optical Particle Sensor Apparatus and Corresponding Particle Measurement Method

(71) Applicants: Robert Bosch GmbH, Stuttgart (DE); TRUMPF Photonic Components GmbH, Ulm (DE)

(72) Inventors: Stefan Weiss, Tübingen (DE); Alexander Herrmann, Reutlingen (DE); Matthias Michelsburg, Reutlingen (DE)

(21) Appl. No.: 16/551,236

(22) Filed: Aug. 26, 2019

(30) Foreign Application Priority Data
Sep. 3, 2018 (DE) 102018214936.4

(51) Int. Cl. G01N 15/06; G08B 6/00; G08B 5/22; G08B 3/10; G08B 7/06; G08B 21/12; H04M 1/02; G08B 29/04

(52) U.S. Cl. CPC G01N 15/06; G08B 6/00; G08B 5/22; G08B 3/10; G01N 2015/0046; G08B 21/12; H04M 1/026; G08B 29/04; G01N 2015/0693; G08B 7/06

(57) ABSTRACT

The present invention provides a portable optical particle sensor apparatus and a corresponding particle measurement method. The portable optical particle sensor apparatus is equipped with an optical particle concentration capture device (10) which is set up to determine measured values of an instantaneous particle concentration of predetermined particles in an event-controlled measurement mode, and an event capture device (50; 50′; 50″) for capturing at least one predetermined local event relating to the environment of the optical particle sensor apparatus (10) and for activating the event-controlled measurement mode in response to the capture of the at least one predetermined local event.

The present invention relates to a portable optical particle sensor apparatus and to a corresponding particle measurement method.

Although applicable to any desired optical particle sensor apparatuses, the present invention and the problem on which it is based are described with respect to optical particle sensor apparatuses which are integrated in mobile apparatuses.

### PRIOR ART

Many regions, in particular densely populated regions, are subject to significant pollution caused by airborne dust or airborne particles. This particle pollution is at least partially caused by humans, specifically mainly by the combustion of carbon compounds by industry, road traffic or else air traffic, shipping traffic and rail traffic and by private households. Owing to the geographical arrangement of the individual airborne dust producers, great differences in the local particle pollution can be observed. This applies outdoors and within closed spaces.

It is known that airborne dust can result in adverse health effects depending on the amount and composition, in which case the inhalable part of the airborne dust is primarily responsible for this. The individual health risk depends substantially on the extent to which and the length of time for which an individual is exposed to which type of particle pollution. Therefore, there is a need to quantify the local and respectively current particle pollution.

The US “National Air Quality” Standard for Particulate Matter (PM) was used to introduce a categorization of airborne dust in PMₓ fractions, which categorization takes into account the size or the diameter x of the dust particles and therefore the penetration depth of these dust particles into the airways and into the body of an individual. A distinction is made in this case, in particular, between coarse dust PM₁₀, which comprises particles with a diameter of up to 10 μm, fine dust PM_{2.5} with particles having a diameter of up to 2.5 μm and ultra-fine dust PM₁ with particles having a diameter of up to 1 μm.

The airborne dust or particle pollution is often quantified using this PM standard. For this purpose, the dust particle mass per volume captured within a period is stated for at least one of the fractions PMₓ.

The quantification of the particle pollution in question here is based on capturing the number of dust particles within a volume. Taking the PM categorization and known models for the size and mass distribution of dust particles as a basis, it is therefore possible to determine a very good estimated value for the particle pollution in the unit of dust particle mass per volume. However, the variable, number of particles per volume, also makes it possible to quantify the particle pollution using other approaches.

PM2.5 fine dust, in particular, is one of the globally worst health threats. PM2.5 fine dust particles can penetrate deep into the lung and can cause serious health damage there. The WHO estimates that several million premature deaths each year are caused by fine dust. The WHO recommends a limit value of 10 μg/m³ for PM2.5 fine dust which should not be exceeded. The observation of the health risks associated with fine dust has greatly increased globally in recent years. In the meantime, PM2.5 pollution values at many locations throughout the world can be retrieved via the Internet. However, the available PM2.5 pollution values relate only to the proximity of the respective measurement stations outdoors.

However, many persons frequently change their whereabouts during the day and are accordingly exposed to variable PM2.5 pollution values during the course of the day which typically differ from the publicly available pollution values. This applies, in particular, to the whereabouts in closed spaces. Hitherto, it was therefore not possible to obtain reliable PM2.5 pollution values for persons over a longer period, for example over the course of a day of 24 hours.

The progressive miniaturization of particle sensors in recent years opens up new possibilities for integrating such particle sensors in mobile devices, for example smartphones or the like. As a result, it is now fundamentally possible to determine an average PM2.5 pollution value for a person who constantly carries such a particle sensor.

DE 10 2015 207 289 A1 discloses an optical particle sensor apparatus having a VCSEL laser diode with an integrated photodiode. A VCSEL laser diode (VCSEL=vertical-cavity surface-emitting laser) is a light-emitting diode in which the light is emitted perpendicular to the plane of the semiconductor chip. The self-mixing interference technology makes it possible for the known optical particle sensor apparatus to obtain information relating to a presence of particles, in particular a particle count and a particle speed.

FIG. 4 is a block diagram for explaining an optical particle sensor apparatus known from DE 10 2015 207 289 A1.

In FIG. 4, reference sign 50a denotes an optical emitter device and 50b denotes an optical detector device, wherein the optical emitter device 50a is a VCSEL laser and the optical detector device 50b is a photodiode. The optical emitter device 50a and the optical detector device 50b are integrated in a VCSEL sensor chip 66 in which a self-mixing interference analysis function is integrated. The optical emitter device 50a emits an optical measurement beam 52. A lens device 58 is used to focus the optical measurement beam 52 in a focus area 60 in which the particles 56 are intended to be captured.

The measurement beam 62 which is scattered by the particles is focused by the lens device 58 onto a detecting surface 64 of the VCSEL sensor chip 66. An optional mirror device 74 makes it possible to shift the focus area 60 in a one-dimensional or two-dimensional manner within the focus area 60.

The optical detector device 50b is designed to output an information signal 68 relating to an intensity and/or an intensity distribution of the scattered electrical measurement beam 62 which occurs on the detecting surface 64. An evaluation device 70 provides an information signal 72 relating to a presence of the particles 56, a particle count and/or another property of the particles 56. In particular, the particle speed is also of interest.

US 2016/0025628 A1 discloses a smartphone having an integrated optical particle sensor apparatus.

### DISCLOSURE OF THE INVENTION

The present invention provides a portable optical particle sensor apparatus according to independent Claim 1 and a corresponding particle measurement method according to independent Claim 19.

The respective subclaims relate to preferred developments.

### Advantages of the Invention

The idea on which the present invention is based is that of determining measured values of an instantaneous particle concentration in an event-controlled measurement mode. In response to capture of a predetermined local event relating to the environment of the optical particle sensor apparatus, the event-controlled measurement mode is activated. In the case of predefined local events which entail an expected change in the particle concentration, this makes it possible to react immediately by virtue of the event-controlled measurement mode.

According to one preferred embodiment, the optical particle concentration capture device is set up to determine measured values of the instantaneous particle concentration of predetermined particles in a time-controlled measurement mode, on which the event-controlled measurement mode is superimposed. This combination makes it possible, on the one hand, to make the measurement intervals in the time-controlled measurement mode battery-saving and, on the other hand, to react immediately in the case of local events which entail an expected change in the particle concentration by virtue of the event-controlled measurement mode.

According to another preferred embodiment, an evaluation device for determining an average particle concentration over a predetermined period on the basis of the measured values is provided. An average particle concentration of predetermined particles over a predetermined period, for example 24 h, can therefore be captured.

According to another preferred embodiment, the event capture device has a location change capture device for capturing a predetermined geographical location change as the predetermined local event. It is therefore possible to define in advance location changes which entail an expected change in the particle concentration with a high degree of probability.

According to another preferred embodiment, the predetermined geographical location change comprises entering or leaving a building or a building area.

According to another preferred embodiment, the location change capture device is connected to a sensor device for capturing a WiFi signal strength and/or a GPS signal and/or a Bluetooth signal and/or a GSM signal strength and/or an EM signal strength, in particular light intensity or terrestrial magnetic field strength. Location changes can therefore be captured with a high degree of accuracy.

According to another preferred embodiment, the event capture device is connected to a sound capture device for capturing a local sound level and comprises a sound determination device for determining a predetermined sound pattern as the predetermined local event. It is therefore possible to define in advance sound patterns which entail an expected change in the particle concentration with a high degree of probability.

According to another preferred embodiment, the predetermined sound pattern results from actuation of a device. Examples of such devices are, in particular, vacuum cleaners, hair dryers, tools, air-conditioning systems, cooking appliances and the like. Such devices regularly have a great influence on the particle concentration within closed spaces.

According to another preferred embodiment, the event capture device comprises an environmental parameter capture device for capturing at least one local environmental parameter and an environmental parameter change determination device for determining a change in the environmental parameter as the predetermined local event. It is therefore possible to define in advance environmental parameters which entail an expected change in the particle concentration with a high degree of probability.

According to another preferred embodiment, the local environmental parameter comprises a local temperature, a local humidity or a local gas atmosphere. Such environmental parameters generally have a great influence on the particle concentration.

According to another preferred embodiment, a first warning device is provided and is set up to output an acoustic and/or optical and/or vibratory warning if the measurement mode cannot be activated. The user can therefore take corresponding precautions in order to enable the measurement mode.

According to another preferred embodiment, a second warning device is provided and is set up to output an acoustic and/or optical and/or vibratory warning if the average particle concentration over the predetermined period or the instantaneous particle concentration exceeds a respective predetermined limit value. Such a warning makes it possible for the user to make a location change to a location which is less polluted or to put on protective equipment, for example a breathing mask.

According to another preferred embodiment, the particle concentration capture device has an optical emitter device for directing an optical measurement beam through an optical exit area to outside a housing into a focus area, within which particles can be captured, and an optical detector device which is arranged in the housing and is intended to capture the measurement beam scattered by particles and to output information relating to the particle concentration. Such a particle concentration capture device can be particularly compact.

According to another preferred embodiment, the optical emitter device has a laser diode, in particular a VCSEL diode, and the optical detector device has a photodiode integrated in the laser diode.

According to another preferred embodiment, the measurement beam and the scattered measurement beam can be analysed by means of an algorithm using the self-mixing interference method.

According to another preferred embodiment, the optical particle sensor apparatus is arranged in a portable apparatus, in particular in a smartphone. This considerably simplifies operation for the user.

According to another preferred embodiment, a transmission device for transmitting the average particle concentration over the predetermined period or the instantaneous particle concentration to a data cloud device is provided. Other persons in the area who not carry a particle sensor apparatus, for example, can therefore benefit from the measured values.

According to another preferred embodiment, the particle concentration is a PM2.5 fine dust concentration. The measured values can therefore be compared with public standards, for example the WHO standard.

### BRIEF DESCRIPTION OF THE DRAWINGS

In the drawings:

FIG. 1 shows a block diagram for explaining a portable optical particle sensor apparatus according to a first embodiment of the present invention;

FIG. 2 shows a block diagram for explaining a portable optical particle sensor apparatus according to a second embodiment of the present invention;

FIG. 3 shows a block diagram for explaining a portable optical particle sensor apparatus according to a third embodiment of the present invention; and

FIG. 4 shows a block diagram for explaining an optical particle sensor apparatus known from DE 10 2015 207 289 A1.

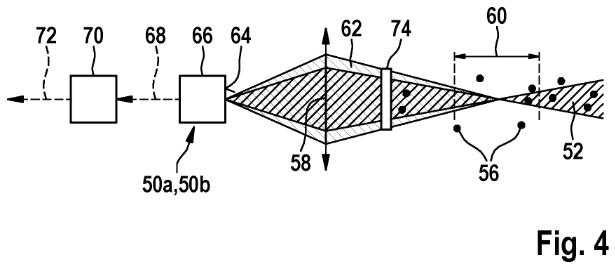

In the figures, identical or functionally identical elements are provided with the same reference signs.

### DESCRIPTION OF THE EXEMPLARY EMBODIMENTS

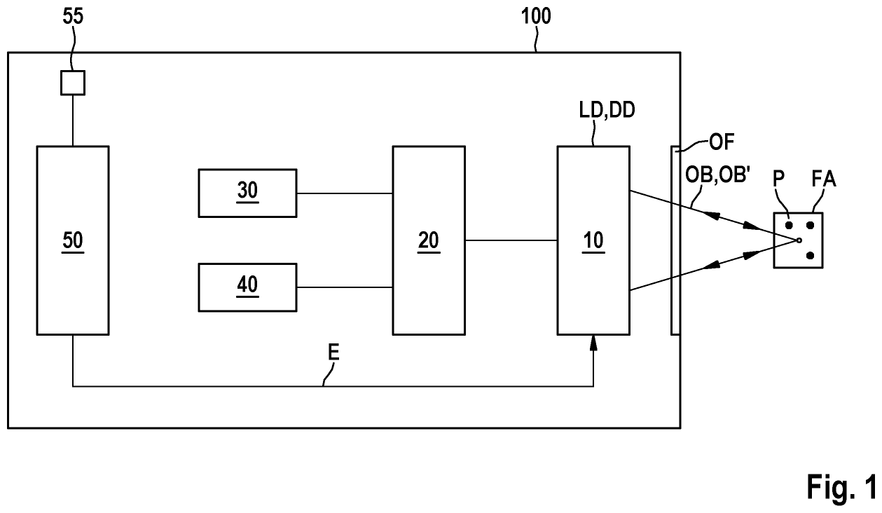

FIG. 1 is a block diagram for explaining a portable optical particle sensor apparatus according to a first embodiment of the present invention.

In FIG. 1, reference sign 100 denotes a housing, for example the housing of a smartphone, in which an optical particle concentration capture device 10 is provided, which device is set up to determine measured values of an instantaneous particle concentration of predetermined articles in a time-controlled measurement mode and in a superimposed event-controlled measurement mode. In the present embodiment, the particles are PM2.5 fine dust particles.

The particle concentration capture device 10 has an optical emitter device LD for directing an optical measurement beam OB through an optical exit area OF to outside the housing 100 into a focus area FA. Particles P can be captured within the focus area FA. An optical detector device DD for capturing the measurement beam OB′ scattered by the particles P and for outputting information relating to the particle concentration is likewise arranged in the housing 100.

In the present embodiment, the optical emitter device LD is a laser diode, in particular a VCSEL diode, and the optical detector device DD is a photodiode integrated in the laser diode. In order to determine the particle concentration, the measurement beam OB and the scattered measurement beam OB′ are analysed by means of an algorithm using the self-mixing interference method.

The measured values of an instantaneous particle concentration of the PM2.5 fine dust particles, as determined by the optical particle concentration capture device 10, are transmitted to an evaluation device 20 which determines an average particle concentration over a predetermined period, for example the course of a day of 24 hours, on the basis of the transmitted measured values.

The time intervals of the time-controlled measurement mode are either preset or can be set by the user and should be such that an energy consumption which is as low as possible is achieved with simultaneously precise measurement results. A display device 30 connected to the evaluation device 20 makes it possible to visually present the instantaneous particle concentration or the average particle concentration for the user.

The average particle concentration and/or the instantaneous particle concentration can be transmitted to a data cloud device (not illustrated) by means of a transmission device 40.

Reference sign 50 denotes an event capture device for capturing predetermined local events relating to the environment of the optical particle sensor apparatus and for activating the superimposed event-controlled measurement mode in response to the capture of the predetermined local events.

In the first embodiment, the event capture device 50 is in the form of a location change capture device 50. It is designed to capture a predetermined geographical location change as the predetermined local event. The predetermined geographical location change involves entering or leaving a building or a building area.

In order to be able to capture the predetermined geographical location change, the location change capture device 50 is connected to a sensor device 55 for capturing a WiFi signal strength and/or a GPS signal and/or a Bluetooth single and/or a GSM signal strength and/or an electromagnetic EM signal strength. The location change capture device 50 determines the predetermined geographical location change either with the aid of a single one of the sensor signals mentioned or by means of a combination of a plurality of sensor signals, which can increase the accuracy.

The location change capture device 50 activates the particle concentration capture device 10 to perform the superimposed event-controlled measurement mode via an accordingly generated event signal E every time such a local event is captured.

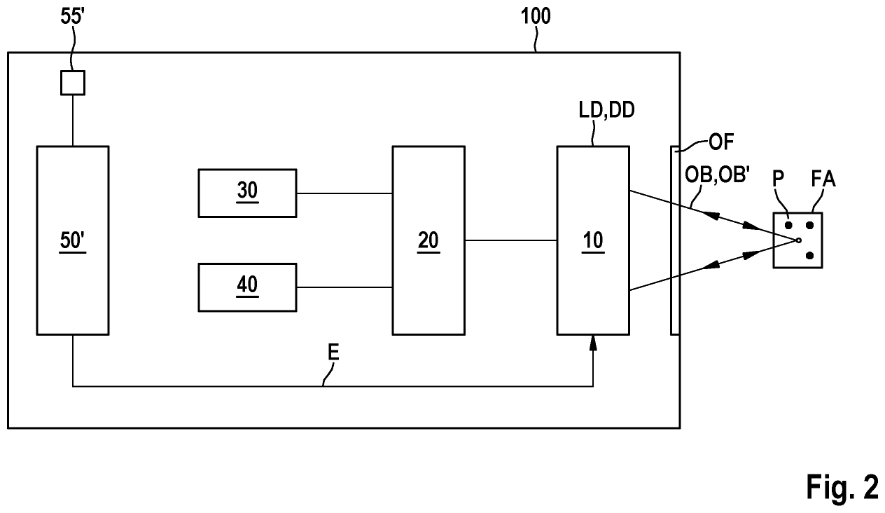

FIG. 2 is a block diagram for explaining a portable optical particle sensor apparatus according to a second embodiment of the present invention.

The structure of the second embodiment differs from the structure of the first embodiment by virtue of the event capture device 50′. In the second embodiment, the event capture device 50′ is connected to a sound capture device 55′ for capturing a local sound level.

The event capture device 50′ is in the form of a sound determination device 50′ for determining a predetermined sound pattern as the predetermined local event.

For example, the predetermined sound pattern comprises actuation of a device, in particular a vacuum cleaner, a hair dryer, a tool, an air-conditioning system, a piece of sports equipment or the like.

Within closed spaces in particular, the actuation of such devices influences the local particle concentration which can be instantaneously captured by the event capture device 50′ and can initiate an event-controlled measurement mode.

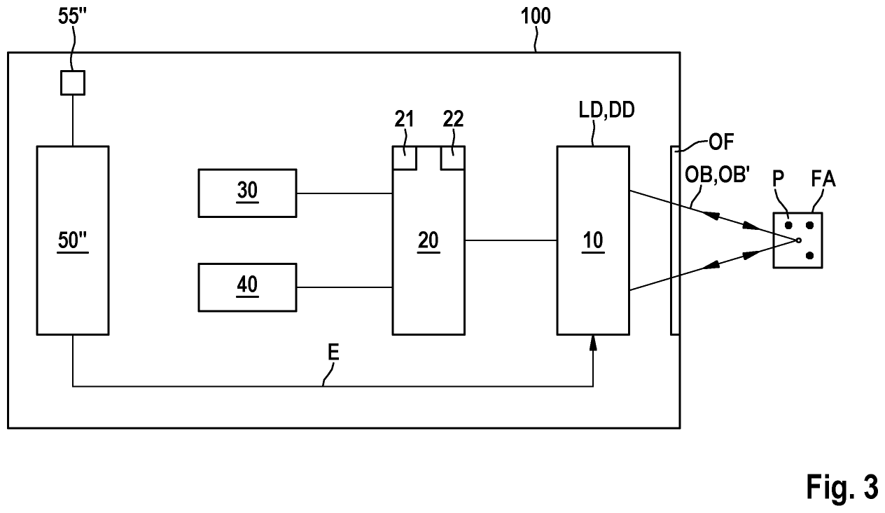

FIG. 3 is a block diagram for explaining a portable optical particle sensor apparatus according to a third embodiment of the present invention.

The structure of the third embodiment differs from that of the second embodiment likewise by virtue of the event capture device 50″. In the third embodiment, the event capture device 50″ comprises an environmental parameter capture device 55″ for capturing at least one local environmental parameter and also an environmental parameter change determination device 50″ for determining a change in the environmental parameter as the local event.

The local environmental parameter is, for example, a local temperature, a local humidity or a local gas atmosphere which can be captured using a corresponding environmental parameter sensor device 55″.

The particle sensor apparatus additionally has a first warning device 21 which is set up to output an acoustic and/or optical and/or vibratory warning if the measurement mode cannot be activated. This makes it possible for the user to immediately reactivate the measurement mode, for example by changing the position of the particle sensor apparatus.

The particle sensor apparatus also has a second warning device 22 which is set up to output an acoustic and/or optical and/or vibratory warning if the average particle concentration over the predetermined period, for example 24 hours, or the instantaneous particle concentration exceeds a respective predetermined limit value. Such a warning can then be displayed on the display device 30 or can be acoustically output via a loudspeaker device (not illustrated).

1. A portable optical particle sensor apparatus having:
an optical particle concentration capture device which is set up to determine measured values of an instantaneous particle concentration of predetermined particles in an event-controlled measurement mode; and
an event capture device for capturing at least one predetermined local event relating to the environment of the optical particle sensor apparatus and for activating the event-controlled measurement mode in response to the capture of the at least one predetermined local event.

2. The portable optical particle sensor apparatus according to claim 1, wherein the optical particle concentration capture device is set up to determine measured values of the instantaneous particle concentration of predetermined particles in a time-controlled measurement mode, on which the event-controlled measurement mode is superimposed.

3. The portable optical particle sensor apparatus according to claim 1, comprising an evaluation device for determining an average particle concentration over a predetermined period on the basis of the measured values.

4. The portable optical particle sensor apparatus according to claim 1, wherein the event capture device has a location change capture device for capturing a predetermined geographical location change as the predetermined local event.

5. The portable optical particle sensor apparatus according to claim 4, wherein the predetermined geographical location change comprises entering or leaving a building or a building area.

6. The portable optical particle sensor apparatus according to claim 4, wherein the location change capture device is connected to a sensor device for capturing one or more of a WiFi signal strength, a GPS signal, a Bluetooth signal, a GSM signal strength, an EM signal strength, a light intensity and a terrestrial magnetic field strength.

7. The portable optical particle sensor apparatus according to claim 1, wherein the event capture device is connected to a sound capture device for capturing a local sound level and comprises a sound determination device for determining a predetermined sound pattern as the predetermined local event.

8. The portable optical particle sensor apparatus according to claim 7, wherein the predetermined sound pattern results from actuation of a device.

9. The portable optical particle sensor apparatus according to claim 1, wherein the event capture device comprises an environmental parameter capture device for capturing at least one local environmental parameter and an environmental parameter change determination device for determining a change in the environmental parameter as the predetermined local event.

10. The portable optical particle sensor apparatus according to claim 9, wherein the local environmental parameter comprises one or more of a local temperature, a local humidity and a local gas atmosphere.

11. The portable optical particle sensor apparatus according to claim 1, wherein a first warning device is provided and is configured and operable to output one or more of an acoustic, an optical and a vibratory warning if the measurement mode cannot be activated.

12. The portable optical particle sensor apparatus according to claim 1, wherein a second warning device is provided and is configured and operable to output one or more of an acoustic, an optical and a vibratory warning if the average particle concentration over the predetermined period or the instantaneous particle concentration exceeds a respective predetermined limit value.

13. The portable optical particle sensor apparatus according to claim 1, wherein the particle concentration capture device has an optical emitter device for directing an optical measurement beam through an optical exit area to outside a housing into a focus area, within which particles can be captured, and an optical detector device which is arranged in the housing and is intended to capture the measurement beam scattered by particles and to output information relating to the particle concentration.

14. The portable optical particle sensor apparatus according to claim 13, wherein the optical emitter device has a laser diode and the optical detector device has a photodiode integrated in the laser diode.

15. The portable optical particle sensor apparatus according to claim 13, wherein the measurement beam and the scattered measurement beam are analysed by means of an algorithm using the self-mixing interference method.

16. The portable optical particle sensor apparatus according to claim 1, which is arranged in a smartphone.

17. The portable optical particle sensor apparatus according to claim 1, further comprising a transmission device for transmitting the average particle concentration over the predetermined period or the instantaneous particle concentration to a data cloud device.

18. The portable optical particle sensor apparatus according to claim 1, wherein the particle concentration is a PM2.5 fine dust concentration.

19. A portable measurement method comprising the steps of:
determining measured values of an instantaneous particle concentration of predetermined particles in an event-controlled measurement mode; and
capturing at least one predetermined local event relating to the environment of the optical particle sensor apparatus; and
activating the event-controlled measurement mode in response to the capture of the at least one predetermined local event.

20. The portable measurement method according to claim 19, wherein the predetermined local event comprises entering or leaving a building or a building area.

21. The portable measurement method according to claim 19, wherein the predetermined local event results from actuation of a device.

22. The portable measurement method according to claim 19, wherein the predetermined local event comprises a change in an environmental parameter.
